(19) United States
(12) Patent Application Publication
(10) Pub. No.: US 2023/0298446 A1
(43) Pub. Date: Sep. 21, 2023

(54) POSITION TRACKING CLASSIFICATION AND METHODS FOR USE THEREWITH

(71) Applicant: Syntiant Corp., Irvine, CA (US)

(72) Inventors: David Garrett, Tustin, CA (US); Chris Stevens, Laguna Nigel, CA (US)

(73) Assignee: Syntiant Corp., Irvine, CA (US)

(21) Appl. No.: 18/170,294

(22) Filed: Feb. 16, 2023

Related U.S. Application Data
(60) Provisional application No. 63/320,546, filed on Mar. 16, 2022.

(51) Int. Cl. G08B 13/24; G06N 3/08; G08B 25/00

(52) U.S. Cl. CPC G08B 13/24; G06N 3/08; G08B 25/001

(57) ABSTRACT

A sensor apparatus includes an interface configured to interface and communicate with a network, a sensor unit configured to measure and report an output representative of a motion state for the sensor apparatus, memory and processing circuitry configured to execute operational instructions to receive the output signal from the sensor unit, where the output signal is representative of one of a plurality of motion states for the sensor unit and the output signal includes information sufficient to determine one or more changes to an environment associated with the sensor apparatus. The processing circuitry is configured to classify, via an artificial intelligence model, the output signal according to previously classified events to produce a classified output determine whether to transmit a notification to the network.

### CROSS-REFERENCE TO RELATED APPLICATIONS

The present U.S. Utility Patent Application claims priority pursuant to 35 U.S.C. §119(e) to U.S. Provisional Application No. 63/320,546, entitled “CLASSIFICATION OF POSITION TRACKING EVENTS”, filed Mar. 16, 2022, which is hereby incorporated herein by reference in its entirety and made part of the present U.S. Utility Patent Application for any and all purposes.

### FIELD OF THE DISCLOSURE

The subject disclosure relates to circuits and systems for sensor systems and associated client devices for home and office monitoring and security.

### BRIEF DESCRIPTION OF THE DRAWINGS

Reference will now be made to the accompanying drawings, which are not necessarily drawn to scale, and wherein:

FIG. 1A illustrates a sensing ecosystem in accordance with various aspects described herein;

FIG. 1B illustrates another sensing ecosystem in accordance with various aspects described herein;

FIG. 2A is a pictorial block diagram illustrating an example sensor device;

FIG. 2B is a pictorial block diagram illustrating another example sensor device;

FIG. 3 illustrates an example inclination sensor for detecting a level angle in two directions in accordance with various aspects described herein;

FIG. 4 illustrates sensitivity axes for an example 3-axis accelerometer in accordance with various aspects described herein;

FIG. 5 illustrates a 6-axis Inertial Measurement Unit (IMU) in accordance with various aspects described herein;

FIG. 6 illustrates a 9-axis Inertial Measurement Unit (IMU) in accordance with various aspects described herein;

FIG. 7A illustrates the orientation and sensitivity axes for the accelerometers and rotation polarity for the gyroscopes in an example a 9-axis Inertial Measurement Unit (IMU) in accordance with various aspects described herein;

FIG. 7B illustrates the orientation and sensitivity axes for the magnetometers in a 9-axis IMU in accordance with various aspects described herein;

FIG. 8 is a block diagram illustrating an example sensor module;

FIG. 9 is a block diagram illustrating another example sensor module;

FIGS. 10A-10D illustrate example sensor devices coupled to moveable structures in accordance with various aspects described herein;

FIG. 11 is a flow diagram of an example method in accordance with various aspects described herein;

FIGS. 12A-12D illustrate example sensor devices coupled to structures for monitoring various phenomena in accordance with various aspects described herein;

FIG. 13 is a flow diagram of an example method in accordance with various aspects described herein;

FIG. 14 is a flow diagram of an example method in accordance with various aspects described herein; and

FIG. 15 is a flow diagram of an example method in accordance with various aspects described herein.

### DETAILED DESCRIPTION

One or more examples are now described with reference to the drawings. In the following description, for purposes of explanation, numerous details are set forth in order to provide a thorough understanding of the various examples. It is evident, however, that the various examples can be practiced without these details.

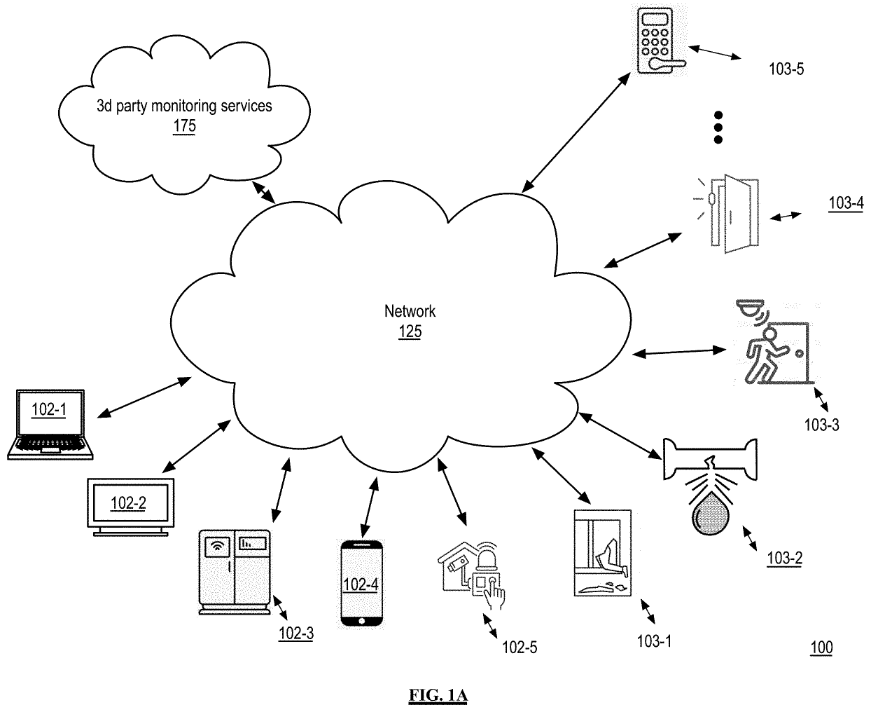

FIG. 1A is a pictorial block diagram illustrating an example sensor device and client device ecosystem 100 in accordance with various aspects described herein. As shown, client devices (generically, 102-x) include a laptop of other personal computer 102-1, a smart television or other video display device 102-2, a connected refrigerator or other smart appliance 102-3 a smart phone or other personal communication device 102-4 and a security system 102-5. Each of these client devices 102-x includes a network interface for communicating with via a network 125. Examples of such network interfaces include, for example, Bluetooth transceivers, Ultra-Wideband (UWB) transceivers, WiFi transceivers (802.11a—802.11xx), 4G, 5G or other cellular data transceivers, WIMAX transceivers, ZigBee transceivers, Z-wave transceivers, 6LoWPAN transceivers, IPV6 transceivers based on THREAD, or other wired or wireless communication interfaces.

A shown, sensor devices (generically “103-x”) include 103-6, a window sensor 103-1, a water leak sensor 103-2, a motion sensor 103-3, a door sensor 103-4 and a smart lock or other Internet of things (IoT) device 103-5. Sensor devices 103-x are representative of a plethora of sensing instruments available. Accordingly, the block diagram of FIG. 1A is intended to provide a sampling of such sending instruments.

In various examples, the network 125 can facilitate communication between client devices (generically “102-x”) and sensors 103-x, as well as between a client devices 102-x, a sensor 103-x and 3rd party providers, such as security providers, monitoring services, law enforcement entities, private security entities and smart databases 185. The network 125 can include the Internet or other wide area network, a home network, a virtual private network or other private network, a personal area network and/or other data communication network including wired, optical and/or wireless links.

The client devices 102-x and sensors 103-x include circuits and systems for sensing events, calibration, data interpretation, data translation, data aggregation, triggering of alarm or signaling system(s), audio signal processing, video processing and, in operation, the client devices 102-x and sensors 103-x, either alone or in combination, can process input signals as described in conjunction with one or more figures that follow.

Sensors 103-x can comprise simple mechanisms, such as mechanical switches, magnetic switches, thermocouples, impedance devices, accelerometers, gyroscopes, magnometers, passive infrared sensors, thermal sensors, image sensors, manometers, voltmeters, acoustic sensors, acoustic wave sensors, flow sensors, pressure sensors, force sensors, compression load sensors, compression sensors, vibration sensors etc. and can be used to measure physical properties of items or systems, including, but not limited to temperature, humidity, pressure, flow, motion, and force. Sensors 103-x can also comprise more complex mechanisms designed to sense movement in multiple axes and combinations of physical properties with movement.

FIG. 1B is a pictorial block diagram illustrating another example sensor device and client device ecosystem 200 in accordance with various aspects described herein. As shown, client devices (generically, 102-x) include a laptop of other personal computer 102-1, a smart television or other video display device 102-2, a connected refrigerator or other smart appliance 102-3 a smart phone or other personal communication device 102-4 and a security system 102-5. Each of these client devices 102-x includes a network interface for communicating with via a network 125. Examples of such network interfaces include, for example, Bluetooth transceivers, Ultra-Wideband (UWB) transceivers, WiFi transceivers (802.11a—802.11xx), 4G, 5G or other cellular data transceivers, WIMAX transceivers, ZigBee transceivers, Z-wave transceivers, 6LoWPAN transceivers, IPV6 transceivers based on THREAD, or other wired or wireless communication interfaces.

A shown, sensor devices (generically “103-x”) include 103-6, a window sensor 103-1, a water leak sensor 103-2, a motion sensor 103-3, a door sensor 103-4 and a smart lock or other Internet of things (IoT) device 103-5. Sensor devices 103-x are representative of a plethora of sensing instruments available. Accordingly, the block diagram of FIG. 1A is intended to provide a sampling of such sending instruments.

In various examples, local area network (LAN) 105 can facilitate communication between client devices (generically “102-x”) and sensors 103-x, as well as between a client devices 102-x, a sensor 103-x and wide area network (WAN) 127. LAN 105 can include a home network or other private network, one or more personal area networks (PANs) and/or other data communication network including wired, optical and/or wireless links. In an example, LAN 105 can be configured to consolidate communication traffic from one or more of sensors 103-x for potential sharing with one or more 3d party monitoring services 175 and/or one or more data analysis services 115. In a related example, the ecosystems 100 and/or 200 can include progressive levels of network traffic consolidation, such that nested sensors 103-x can provide classified event data to LAN 105 for further consolidation at LAN 105 or, to an intermediate intelligent agent that can then consolidate classified event data from a plurality of nested sensors 103-x for use at LAN 105.

The client devices 102-x and sensors 103-x include circuits and systems for sensing events, calibration, data interpretation, data translation, data aggregation, triggering of alarm or signaling system(s), audio signal processing, video processing and, in operation, the client devices 102-x and sensors 103-x, either alone or in combination, can process input signals as described in conjunction with one or more figures that follow.

Sensors 103-x can comprise simple mechanisms, such as mechanical switches, magnetic switches, thermocouples, impedance devices, accelerometers, gyroscopes, magnometers, passive infrared sensors, thermal sensors, image sensors, manometers, voltmeters, acoustic sensors, acoustic wave sensors, flow sensors, pressure sensors, force sensors, compression load sensors, compression sensors, vibration sensors etc. and can be used to measure physical properties of items or systems, including, but not limited to temperature, humidity, pressure, flow, motion, and force. Sensors 103-x can also comprise more complex mechanisms designed to sense movement in multiple axes and combinations of physical properties with movement.

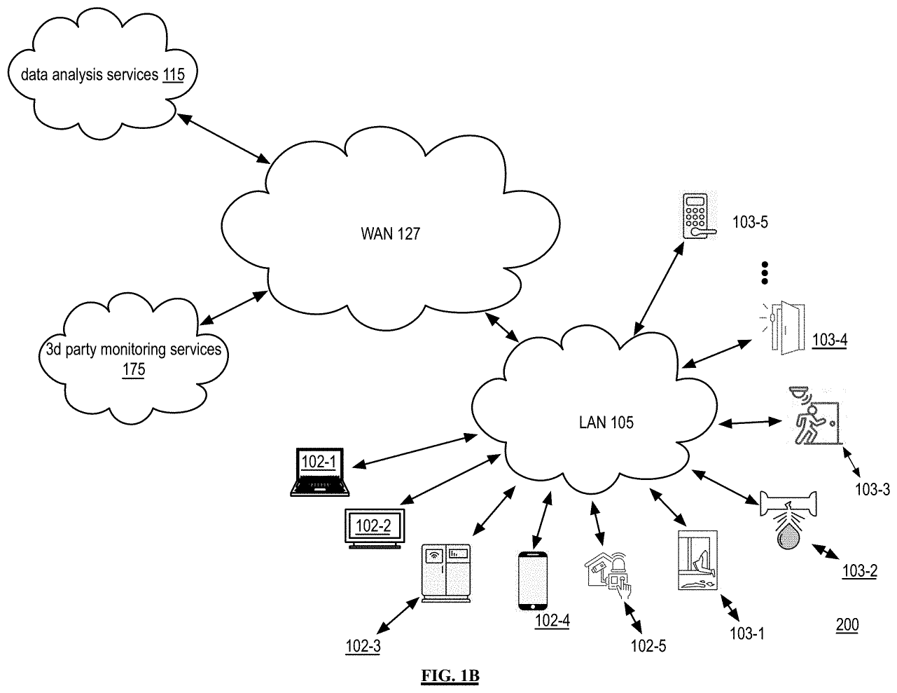

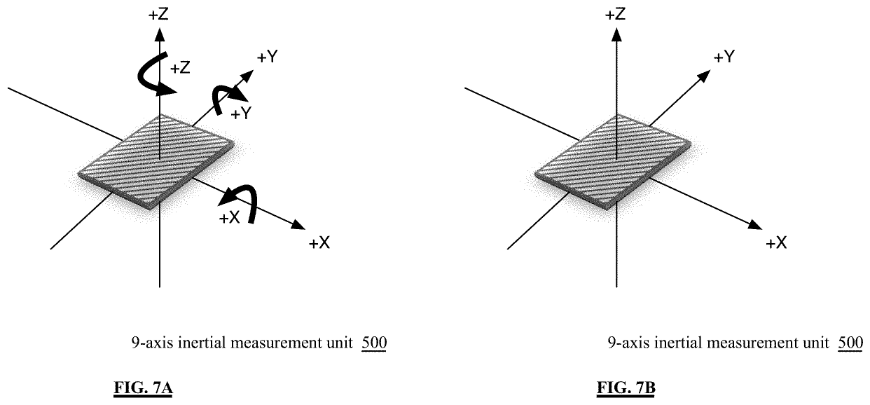

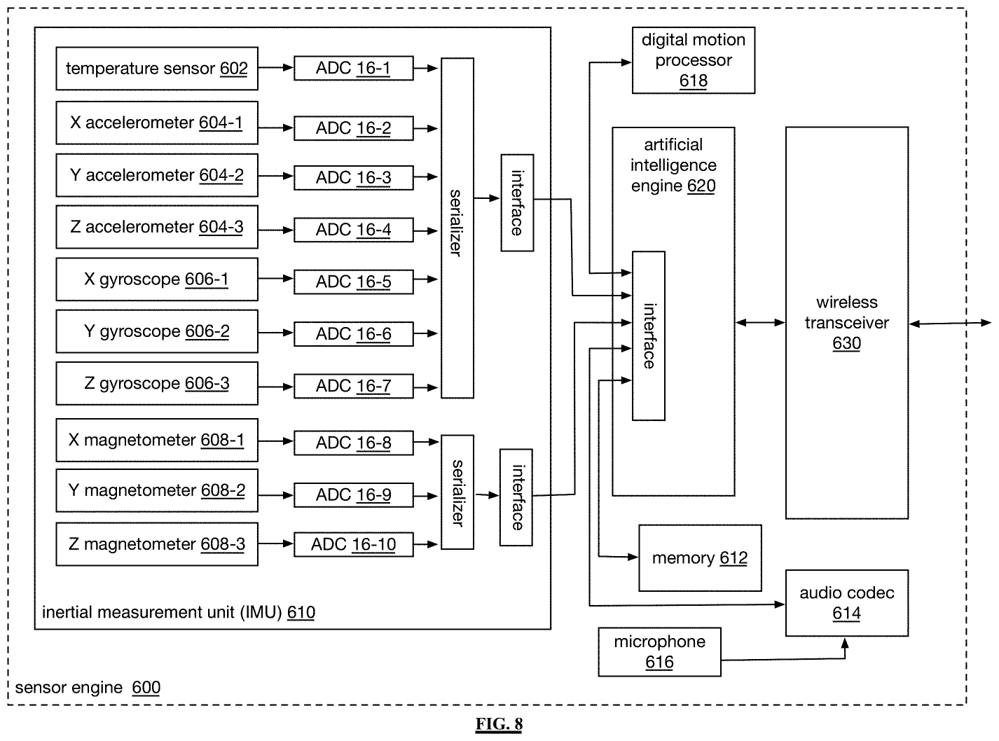

FIG. 2A is a pictorial block diagram illustrating an example sensor device 300. In the example, a sensor 302 is coupled to an edge classifier engine 304, described in detail with reference to FIGS. 8 and 9, below. Edge classifier engine 304 is coupled to decision engine 306 and is configured to receive sensor data from sensor 302 and provide classification information for the received sensor data to decision engine 306. Decision engine 306 is adapted to execute one or more determinations, such as whether and/or when to transmit information representative of the classification data received from edge classifier engine 304 and, when appropriate, provide it for transmission by wireless transceiver 308, which is coupled to the output of decision engine 306.

FIG. 2B is a pictorial block diagram illustrating another example sensor device 320. In the example, multiple sensors 310-1-310-N are coupled to an edge classifier engine 312 as also further described in detail with reference to FIGS. 8 and 9, below. Edge classifier engine 312 is coupled to decision engine 314 and is configured to receive sensor data from sensors 310-1-310-N and provide classification information for the received sensor data to decision engine 314. Decision engine 314 is adapted to execute one or more determinations, such as whether and/or when to transmit information representative of the classification data received from edge classifier engine 312 and, when appropriate, provide it for transmission by wireless transceiver 308, which is coupled to the output of decision engine 306.

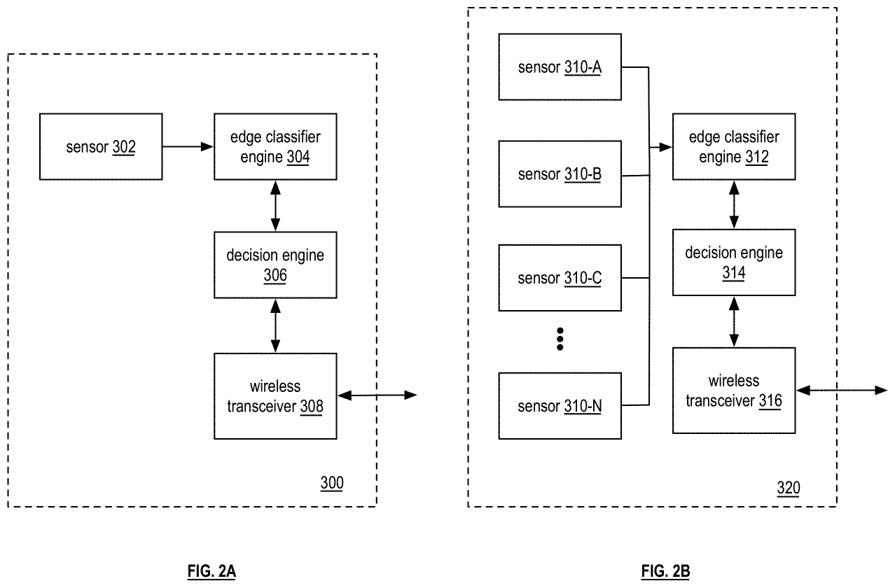

FIG. 3 illustrates an example inclination sensor apparatus 200 for detecting a level angle in two directions. In the example, a change in level angle or “inclination” of an item, such as substrate 202 can be sensed and converted to an electrical signal. In a specific example, inclination sensor 204 is coupled to substrate 202, enabling position detection for substrate 202, and further enabling substrate 202 to be accurately leveled during placement and/or use. In a related example, when substrate 202 is a moveable object, inclination sensor 204 can be used to provide highly accurate location and level information associated with the moveable object. In the example, rotation about an axis X of inclination sensor 204 (between X− and X+) and/or rotation about an axis Y of inclination sensor 204 (between Y− and Y+) can be measured such that level angle is known in 2-axes.

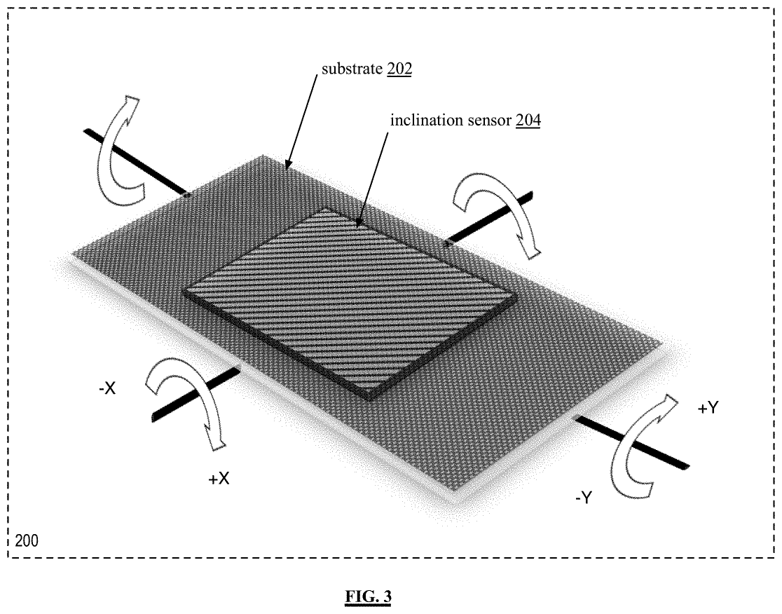

FIG. 4 illustrates sensitivity axes for an example 3-axis accelerometer apparatus 208. In an example, an accelerometer is a sensor that can measure the rate of change of velocity of an object in relation to the 3 Cartesian coordinate axes (X, Y and Z). In the example, 3-axis accelerometer 206 is adapted to measure acceleration in three axes that are linked to each other, such that the reference for acceleration applied to substrate coupled to 3-axis accelerometer xxx can be known relative to the substrate itself. Accordingly, 3-axis accelerometer 206 cannot be used to measure a change in position of the substrate, thus if the substrate is rotated, the orientation of the 3 axes would change. Said another way, a substrate coupled to 3-axis accelerometer 206 placed at the center of a system, adjusting one of its axes to the rotation of the substrate, would not enable 3-axis accelerometer 206 to detect changes in the rotational speed of the substrate.

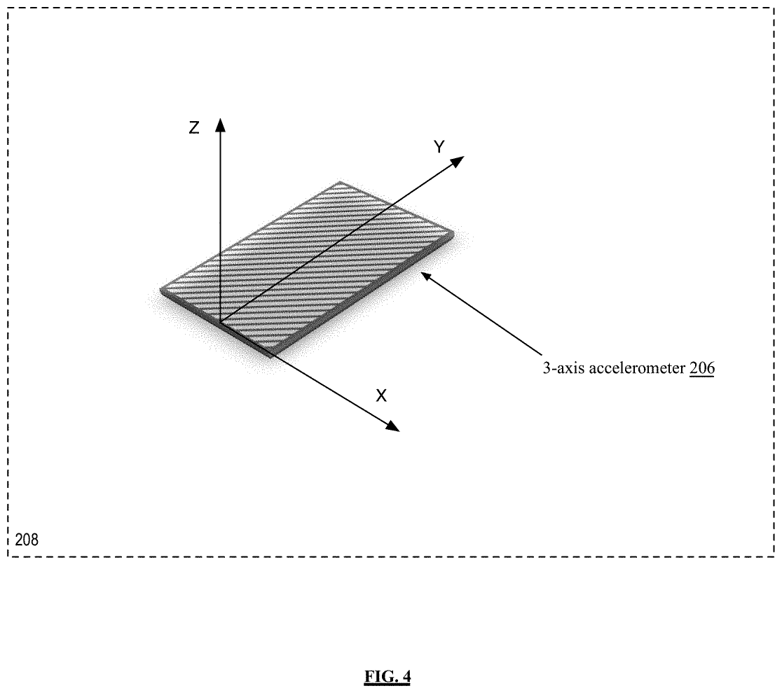

FIG. 5 illustrates a 6-axis Inertial Measurement Unit (IMU). An IMU can be configured to measures and report the specific force, angular rate, and sometimes the orientation of a body. It can include gyroscopes and accelerometers, such as the accelerometers described with reference to FIG. 4. A gyroscope is a sensor that can measure the angular rate of an object's motion. In the example of 6-axis inertial measurement unit 400, a gyroscope (402-2, 402-3 and 402-1) and an accelerometer (404-2, 404-3 and 404-1) is provided in each of an X, Y and Z axis, respectively. Together these sensors provide 6 component motion sensing: accelerometers for X, Y and Z movement, and gyroscopes for measuring the extent and rate of rotation in space. The 6-axis IMU can provide measure and report relative stability by considering movements caused by vibrations. At any one moment in time either the gyroscope or accelerometer can be independently turned off to provide a lower power operating state.

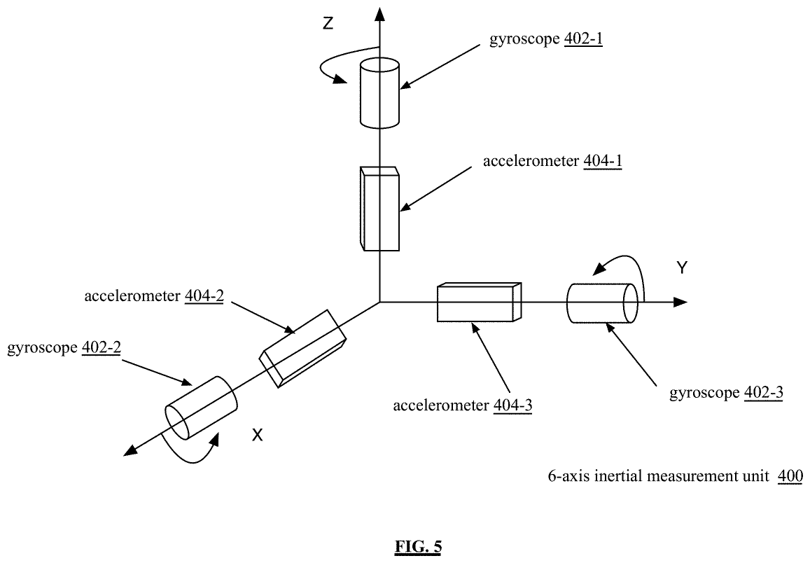

FIG. 6 illustrates a 9-axis Inertial Measurement Unit (IMU). 9-axis inertial measurement unit 500 comprising, for example, gyroscopes (502-2, 502-3 and 502-1) and accelerometers (504-2, 504-3 and 504-1), such as those illustrated with reference to the 6-axis inertial measurement unit 400 of FIG. 5, with a magnetometer (506-2, 506-3 and 506-1) a provided in each of an X, Y and Z axis, respectively. In an example, a magnetometer is a device that measures magnetic field or magnetic dipole moment. In various examples, a magnetometer (such as a compass) can be used to measure the direction, strength, or relative change of a magnetic field at a particular location. In the example of a compass, a magnetometer can be adapted to record the effect of a magnetic dipole on the induced current in a coil. As relevant to various examples herein, a magnetometer can be used to provide absolute angular measurements relative to the Earth's magnetic field. As with the 6-axis IMU, each of the sensors: accelerometer, gyroscopes and magnetometer, can be enabled for a lower power operating state. In an example, one or more accelerometers of an IMU can be configured for relatively constant operation (i.e. the one or more accelerometers are powered either continuously or according to an on/off duty-cycle), while remaining sensors are not powered (i.e. the sensors are “sleeping”). In a related example, when the powered one or more accelerometers sense any movement/motion the sensor apparatus is adapted to power up one or more of the temporarily unpowered (sleeping) sensors for classification by the artificial intelligence engine. In an example, once the motion has been classified the sensors, with the exception of any constant operation sensor(s) can be turned off until another movement/motion is sensed by the constantly powered sensor.

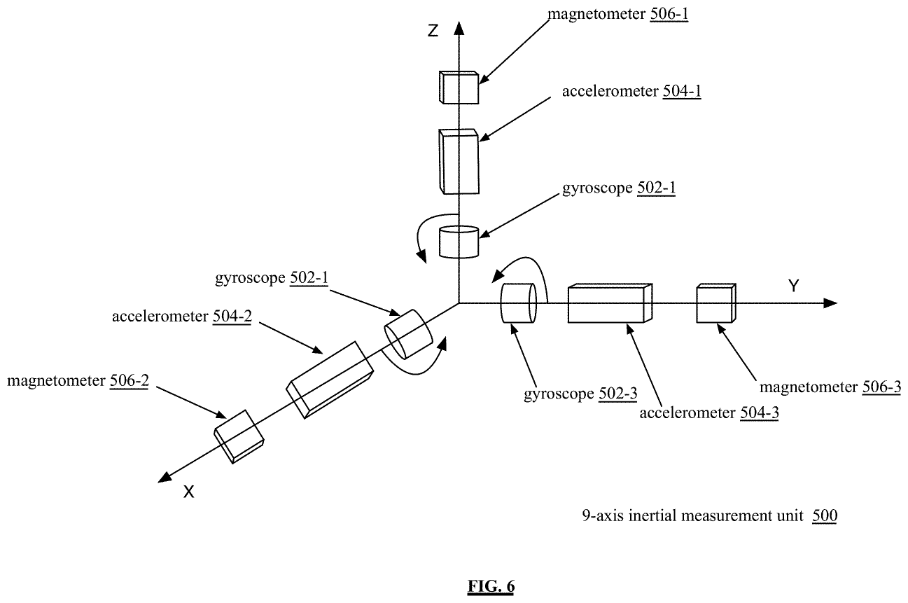

FIG. 7A illustrates the orientation and sensitivity axes for the accelerometers, along with the rotation polarity for the gyroscopes in an example the 9-axis Inertial Measurement Unit (IMU) 500 illustrated with reference to FIG. 6. In the example, each of Y+, X+ and Z+ includes an acceleration component (shown as an arrow extending from the center point of IMU 500, and a rotational component (shown as a rotational arc arrow for each of Y+, X+ and Z+. FIG. 7B illustrates the orientation and sensitivity axes for the magnetometers in a 9-axis IMU 500 illustrated with reference to FIG. 6. In an example of implementation and operation, a 9-axis IMU is coupled to a moveable object, enabling the sensing/measurement of a rate of change of velocity of the object, the angular rate of the object's motion and the absolute angular measurements relative to the Earth's magnetic field for the object.

FIG. 8 is a block diagram illustrating an example sensor engine 600. In particular, the sensor engine 600 includes an inertial measurement unit (IMU) 610, an artificial intelligence engine 620, an optional digital motion processor 610 and a wireless transceiver 630. In a specific example of implementation and operation, IMU 610 is a 9-axis IMU that includes three accelerometers (604-1, 604-2 and 604-3), three gyroscopes (606-1, 606-2 and 606-3) and three magnetometers (608-1, 608-2 and 608-3), one each for the 3 Cartesian coordinate axes (X, Y and Z). In an example, each sensor is coupled to an associated analog to digital converter (ADC 16-1—16-10) and one or more serializers are included to receive the output from each of ADC 16-1—16-10. In an example, an interface is adapted to communicate with artificial intelligence engine 620 over a serial communication bus, using an interface such as, for example only, I²C or a serial peripheral interface (SPI). In a specific example, digital motion processor 618 is coupled to artificial intelligence engine 620 to offload complex motion functions. In an alternate example, digital motion processor 618 can be implemented before sensor outputs are transmitted to artificial intelligence engine 620. In yet another example, motion functions can be bypassed, with artificial intelligence engine 620 using the sensor outputs directly for classification functions. In an example, IMU 610 can include a temperature sensor 602 to correct for temperature dependent anomalies, such as, for example, gyroscope NULL drift.

In an example, artificial intelligence engine 620 can be implemented via a single processing device or a plurality of processing devices. Such processing devices can include a microprocessor, micro-controller, digital signal processor, microcomputer, central processing unit, quantum computing device, field programmable gate array, programmable logic device, state machine, logic circuitry, analog circuitry, digital circuitry, and/or any device that manipulates signals (analog and/or digital) based on operational instructions that are stored in a memory, such as memory 612. Memory 612 can include a hard disc drive or other disc drive, read-only memory, random access memory, volatile memory, non-volatile memory, static memory, dynamic memory, flash memory, cache memory, and/or any device that stores digital information. In an example of implementation, memory 612 can be adapted to cache interim operational/mathematical products, such as convolutions used in artificial neural network training and/or back propagation functions. Note that when the artificial intelligence engine 620 implements one or more of its functions via a state machine, analog circuitry, digital circuitry, and/or logic circuitry, the memory storing the corresponding operational instructions may be embedded within, or external to, the circuitry comprising the state machine, analog circuitry, digital circuitry, and/or logic circuitry.

In a specific example of implementation and operation, artificial intelligence engine 620 can comprise one or more artificial neural networks. In another specific example, the artificial intelligence engine 620 can comprise one or more inference engines, where the one or more inference engines are programmed to use the output of a trained artificial neural network (or artificial neural networks). Example networks can be artificial neural networks, and can use, for example, deep artificial neural networks consisting of dense layers, convolutional layers, recurrent artificial neural networks, attenuation layers, transformers, batch-norm, or residual layers that compose the network. The layers can be processed, for example, with sigmoid, hyperbolic activations, rectified linear units, and softmax operations.

In an example of implementation, sensor engine 600 is coupled to a door. In the example, the one or more artificial neural networks can be trained, based on door opening and door closing events to estimate, based on output from the IMU 610 a door “open” position and a door “closed” position and a relative acceleration and velocity for door opening and door closing events. In a related specific example, door open and closed events can be determined by analyzing output from magnetometers 608-1, 608-2 and 608-3 as the door is repeatedly opened and closed, where the door open and closed positions are updated iteratively as the door is moved between the door angle extremes. In an alternative example, the sensor module is coupled to a door adapted to open and close in a linear motion, such as a sliding door. In the sliding door example one or more accelerometers (such as accelerometers 604-1, 604-2 or 604-3) can be used to train an artificial neural network for door “open” position and a door “closed” positions and a relative acceleration and velocity for door opening and door closing events.

In another specific example of implementation and operation, one or more artificial neural networks comprised in artificial intelligence engine 620 can be trained to classify events associated with a moveable object, such as the door described above. In an example, the one or more artificial neural networks can identify a “door slam” event, enabling, for example determination of a door closed position. Additional examples include identifying a door knock event, based on vibrations, audio or other sensed movement, with a notification, for example, being transmitted using the wireless interface 630. In another example, an attempt to open a closed door can be identified, based on, for example, motion associated with manipulation of a door handle. Additional examples can include other commercial and smart home applications, such as counting persons crossing a door threshold, door opening events and entry patterns for patrons/guests/occupants. The detection of a subset of sensors (for example accelerometers 604-1-604-3), can be used to activate one more additional sensors (gyroscopes 606-1-606-3a and magnetometers 608-1-608-3) to provide more detailed motion state information as needed, while maintaining lower available power when no motion states are changing.

In yet another specific example of implementation and operation, events associated with a door, or a window can be identified to improve and/or augment the operation of a security system. Related examples include using an identified door event to arm or disarm various elements in the security system. For example, if an identified event is relatively benign, a camera can be activated, rather than sounding an alarm or some other intrusive response. In another example, a security system can be armed/initiated when an identified door angle indicates that the door is not completely closed. (Note that a simple door sensor, such a magnetic switch, cannot provide any indication other than that a door is open or closed.)

In an example of implementation, sensor engine 600 can include a transducer for converting acoustic waves into an electrical signal, such as optional microphone 616 and audio-codec 614 for processing an audio microphone generated signal. In the example, the microphone can be used to sense acoustic events that can supplement the IMU 610 sensor output, or additional acoustic events, including, but not limited to breaking of glass, ringing doorbell, knocking on a door or window, human voice, animal sounds, etc. In a specific example, the microphone can be configured for sensitivity in ultrasonic wavelengths, enabling artificial intelligence engine 620 to detect additional events or to augment already detected events. In another specific example, the microphone can be configured for sensitivity in subsonic wavelengths, enabling artificial intelligence engine 620 to detect additional events or patterns, such as pre-earthquake and post-earthquake tremors or relatively distant acoustic events. In related example of implementation, the sensor engine 600 is coupled to a window, or any other moveable structure.

In a specific example of implementation and operation, a sensor apparatus includes a first interface configured to interface and communicate with a network and a sensor configured to detect an event associated with a plurality of changes to an environment, where the environment can include any of the circumstances or conditions associated with an object associated with the sensor apparatus. The sensor device includes memory for storing operational instructions and processing circuitry operably coupled to the interface and to the memory configured to execute the operational instructions to receive an output signal from the sensor, where the output signal is representative of the event. In an example, the output signal includes information sufficient to determine each change of the plurality of changes to the environment. The processing circuitry is also configured to classify, using an artificial intelligence model, the output signal according to previously detected events to produce a classified event output and transmit the classified event output to the network.

The sensor apparatus can also include one or more of a digital motion processor, a battery or other power source, a transducer for converting acoustic waves into an electrical signal, an audio codec and a video codec. In an example, the digital motion processor can be adapted to process the output signal from the sensor prior to the processor receiving the output signal from the sensor. In a related example, the included transducer (or transducers) can be one or more of an ultrasonic transducer, a subsonic transducer and/or a transducer sensitive to acoustic waves between 20 Hz and 24 kHz, or even higher frequency.

In a specific example of implementation, the sensor apparatus comprises a module, where the module includes a plurality of sub-modules and at least one sub-module comprises a sensor and another sub-module comprises the processing circuitry.

In another specific example of operation and implementation, a computing device includes a first interface configured to interface and communicate with a network and a sensor configured to detect an event associated with a changes to a magnetic field in a plurality of directions and rotation around a plurality of axes. The sensor device includes memory for storing operational instructions and processing circuitry operably coupled to the interface and to the memory configured to execute operational instructions to receive an output signal from the sensor, where the output signal is representative of the event. In an example, the output signal includes information sufficient to determine change to acceleration in each of a plurality of directions and rotation around each of a plurality of axes. In the example, the processing circuitry is also configured to classify, using an artificial intelligence model, the output signal according to previously detected events to produce a classified event output and transmit the classified event output to the network.

FIG. 9 is a block diagram illustrating another example sensor engine 700. In particular, the sensor module includes a plurality of example sensor devices, including an inertial measurement unit (IMU) 712, such as the IMU 610 of FIG. 8. Other example sensor devices include, but are not limited to, acoustic wave sensor 702, pressure sensor 704, fluid motion sensor 706, force sensor 708 and transducer 710. In an example, the sensor module also includes an artificial intelligence engine 720 and a wireless transceiver 740. In a specific example relevant sensor engine being used with/for motion sensing, sensor engine 7000 can include digital motion processor 714. In a specific example of implementation and operation, IMU 712 is a 9-axis IMU. In an alternative example, IMU 712 is a 6-axis IMU. In another example, IMU 712 is an inclination sensor. In an example with reference to FIG. 8, one more sensors 702-712 is coupled to an associated analog to digital converter such as ADC 16-1, etc. and one or more serializers are included to receive the output from each of one or more ADCs. In an example of implementation, an interface is adapted to communicate with artificial intelligence engine 720 over a serial communication bus, using an interface such as, for example only, I²C or a serial peripheral interface (SPI).

In an example, artificial intelligence engine 720 can be implemented as a single processing device or as plurality of processing devices. Such example processing devices can include a microprocessor, micro-controller, digital signal processor, microcomputer, central processing unit, quantum computing device, field programmable gate array, programmable logic device, state machine, logic circuitry, analog circuitry, digital circuitry, and/or any device that manipulates signals (analog and/or digital) based on operational instructions that are stored in a memory, such as memory 716. In various examples, memory 716 can include a hard disc drive or other disc drive, read-only memory, random access memory, volatile memory, non-volatile memory, static memory, dynamic memory, flash memory, cache memory, and/or any device that stores digital information. In an example of implementation, memory 716 can be adapted to cache interim operational/mathematical products, such as convolutions used in artificial neural network training and/or back propagation functions. Note that when the artificial intelligence engine 720 implements one or more of its functions via a state machine, analog circuitry, digital circuitry, and/or logic circuitry, memory storing the corresponding operational instructions may be embedded within, or external to, the circuitry comprising the state machine, analog circuitry, digital circuitry, and/or logic circuitry.

In a specific example of implementation and operation, artificial intelligence engine 720 can comprise one or more artificial neural networks. In another specific example, the artificial intelligence engine 720 can comprise one or more inference engines, where the one or more inference engines are programmed to use the output of a trained artificial neural network (or artificial neural networks). Example networks can be artificial neural networks, and can use, for example, deep artificial neural networks consisting of dense layers, convolutional layers, recurrent artificial neural networks, attenuation layers, transformers, batch-norm, or residual layers that compose the network. The layers can be processed, for example, with sigmoid, hyperbolic activations, rectified linear units, and softmax operations.

In an example of implementation, a surface acoustic wave sensor can comprise a microelectromechanical system (MEMS) configured to sense modulation of surface acoustic waves to sense a physical phenomenon. In an example, a sensor transduces an input electrical signal into a mechanical wave that, unlike an electrical signal, can be influenced by physical phenomena. In an example, surface acoustic wave sensor can transduce such a mechanical wave back into another electrical signal. In several examples, changes in amplitude, phase, frequency, or time-delay between example input and output electrical signals can be used to measure the presence of a desired phenomenon. In a specific example of implementation and operation, a surface acoustic wave device can consist of a piezoelectric substrate with an input interdigitated transducer (IDT) on a respective side of the surface of the substrate, and an output IDT on another respective side of the substrate. In a related example, a space between the IDTs across which the surface acoustic wave propagates can comprise a delay line, where the signal produced by the input IDT—a physical wave—moves much slower than its associated electromagnetic form, causing a measurable delay that can be used to analyze one or more phenomena associated with a change to an environment.

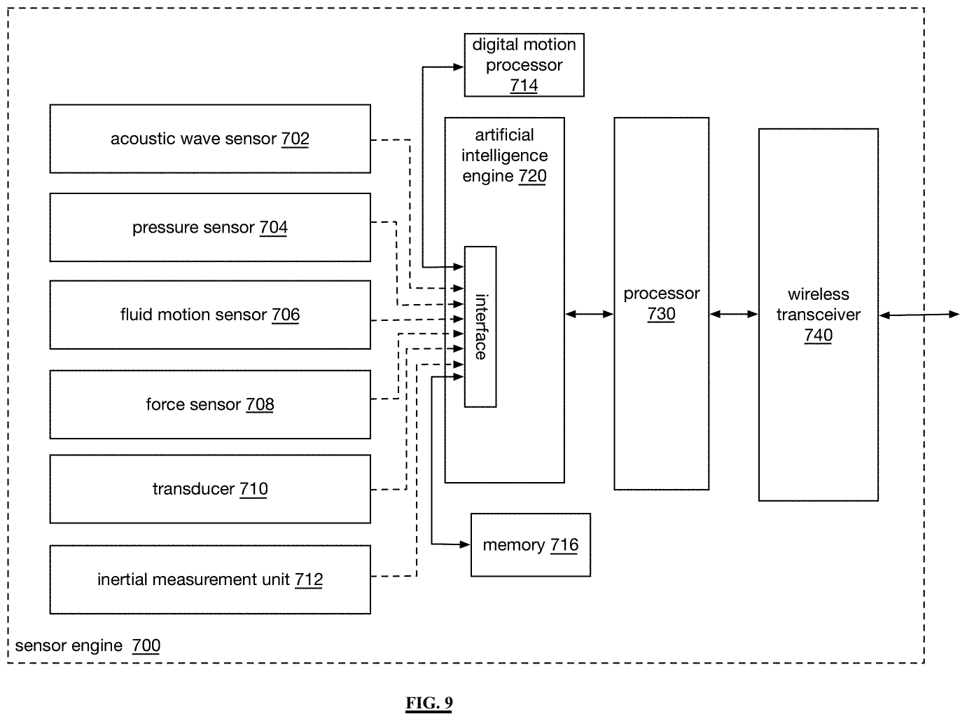

FIGS. 10A-10D illustrate example sensor devices coupled to moveable structures. In each of the 10A-10D, a sensor module 902 is presented that includes a wireless interface 904 such as a Bluetooth transceiver, a WiFi transceiver, a ZigBee transceiver, or other wireless interface. All or a portion of the protocol stack for the sensor can be based on various standards and/or protocols, such as the Internet of Things™ (IOT) standard or using proprietary connectivity rules and criteria, regardless of tan underlying wireless interface. As shown in FIG. 10A, a door 908 is provided comprising a panel that is swingable around rotation axis 906 between closed and open positions. Door 908 will present at a maximum open angle and at infinite angles between maximum and closed, including relative positions, such as mostly closed and mostly open. In an example, door 908 can also present with varying accelerations and velocities as door 908 is opened or closed, along with vibrations associated with door 908 being struck, a lock engaging or disengaging, a handle being exercised and/or vibrations from outside influence, such as wind, explosions, earthquakes, etc. In an example, door 908 can be part of a fixed structure or a moveable apparatus, such as a motor vehicle and/or an aircraft. In an alternative example, door 908 can be a slidable panel. In another example door 908 can be adapted to be rotatable around an axis centered in or close to the middle of door 908. In yet another example, door 908 can be adapted to swing upward and/or door 908 can be adapted to rotate with an articulated double hinge to open into a relatively tight space. In any of these examples a sensor, such as a sensor in sensor module 902 can be adapted to sense an angle of rotation, acceleration, magnetic fields, etc. associated with movement of door 908.

FIG. 10B illustrates sensor module 910 coupled to a nonfixed portion of a hinge 914. In the example, the hinge 914 can be part of a variety of moveable items, such as door 908 of FIG. 10A, such that a sensor, such as a sensor in sensor module 910 coupled to hinge 914 can be adapted to sense angles of rotation, acceleration, magnetic fields, etc. associated with movement of door 908 of FIG. 10A. FIG. 10C illustrates an example sensor module 916 coupled to a pivotable window. As in the examples above referencing FIG. 10A, window 920 will present at a maximum open angle and at infinite angles between maximum and closed, including relative positions, such as mostly closed and mostly open. In an example, window 902 can also present with varying accelerations as window 920 is opened or closed, along with vibrations associated with window 920 being struck and or broken, a lock engaging or disengaging, a handle being exercised and/or vibrations from outside influence, such as wind, explosions, earthquakes, etc. In an example, window 920 can be part of a fixed structure or a moveable apparatus, such as a motor vehicle and/or an aircraft. In another example window 920 can be adapted to be rotatable around an axis centered in or close to the middle of window 920. In another example, window 920 can be adapted to swing upward and/or window 920 can be adapted to rotate with an articulated double hinge to open into a relatively confined space. In yet another example, window 920 can be adapted to include springs, pistons, or other mechanism to assist or moderate the movement of window 920. In any of these examples a sensor, such as a sensor in sensor module 916 can be adapted to sense an angle of rotation, acceleration, magnetic fields, etc. associated with movement of window 920.

FIG. 10D illustrates an example sensor device coupled to a slidable window mechanism. In the example, window 926 includes a window frame and one or more window panes adapted to move in a linear fashion between fully open and fully closed. In an example, window 920 can be adapted to include springs, pistons or other mechanism to assist or moderate the movement of window 920. In the example of FIG. 10D a sensor, such as a sensor in sensor module 920 can be adapted to sense linear movement, acceleration, magnetic fields, etc. associated with movement of window 920.

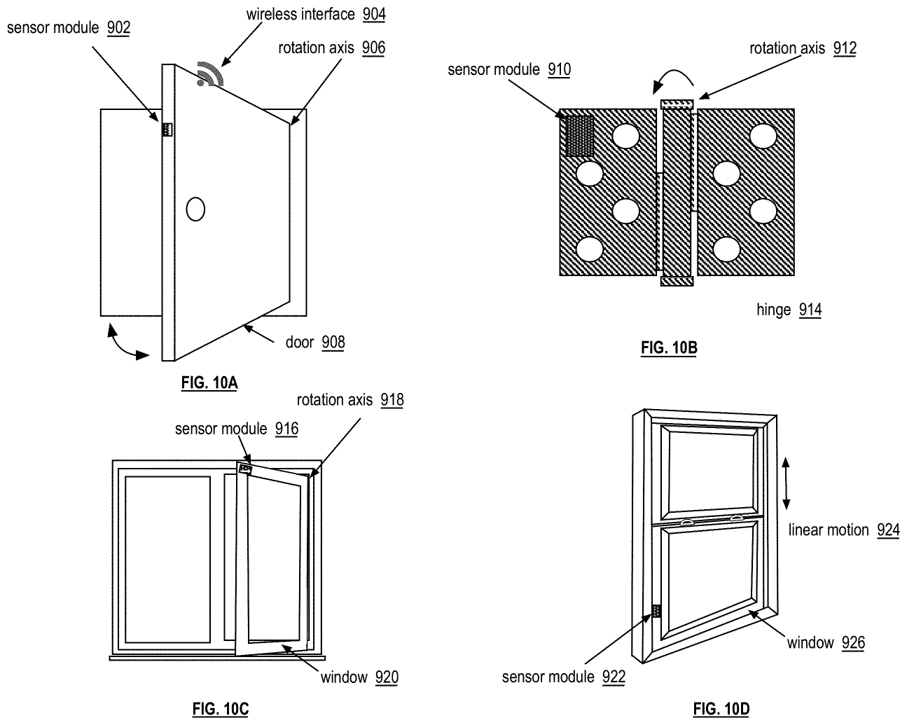

FIG. 11 illustrates a flow diagram 1000 of an example method in accordance with various aspects described herein. In particular, a method 1000 is presented for use with one or more functions and features presented in this disclosure. Step 1002 includes coupling a sensor module to a door or another moveable object. At step 1004 the door is exercised through a range of motion to provide multiple door events. At step 1006 sensor outputs are used to measure and record magnetic field(s), angular motion and rate of change of velocity for the events. Step 1008 includes optionally measuring and recording additional sensor outputs, such as acoustic events, etc. At step 1010, a maximum open and/or closed angle is determined for the subject door.

The method continues at step 1012, with an artificial intelligence engine being used to classify a current event to produce a classified event output. Step 1014 includes transmitting the classified output a network attached element, such as a local security system or a 3rd party monitoring service.

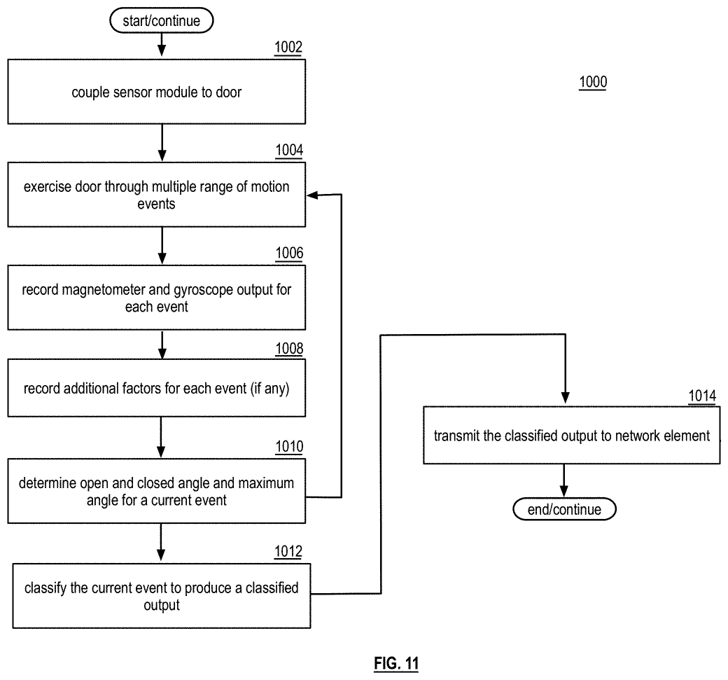

FIGS. 12A-12D illustrate example sensor devices coupled to structures for monitoring various phenomena. FIG. 12A illustrates a pipe or duct with a sensor module 930 coupled to an outside periphery of the pipe or duct. In an example, a break or fissure in the pipe or duct, represented in FIG. 12A as a leak of fluid, can be sensed and measured with one or more sensors in sensor module 930. In an example, sensor module 930 can include, for example, a transducer to capture sound vibration radiating or reflecting from the pipe or duct, either out an outlet, or at a position along the pipe or duct. In another example, a surface wave acoustic device can be configured to capture vibration, relative movement and other phenomena relative to the pipe or duct. In an example, a pipe or duct can present with a variety of vibrations, cyclic movement, with changes in amplitude, phase, frequency, or a time-delay between example input and output electrical signals indicating a potential or actual leak presents in the pipe or duct. In the example, sensor module 930 can be adapted to classify these and other phenomena and used to predict and/or indicate a break or fissure in the pipe or duct.

FIG. 12B illustrates a window with a sensor module 940 coupled to a window pane. In an example, a break-in by a perpetrator can include a break in the window pane, represented in FIG. 12B as a perpetrator entering through a broken window pane. In an example, sensor module 940 can include, for example, a transducer or surface wave acoustic device, to capture vibration, sound, changes in amplitude, phase, frequency, or a time-delay between example input and output electrical signals. In an example, a breaking window can present with a variety of vibrations, sounds and movement indicating that a break-in might have occurred or is still occurring. In the example, sensor module 940 can be adapted to classify these and other phenomena and used to predict and/or indicate a break-in event.

FIG. 12C illustrates a door lock mechanism with a sensor module 950 coupled to it. In an example, sensor module 950 can include, for example, a transducer or surface wave acoustic device, to capture vibration, sound, changes in amplitude, phase, frequency, or a time-delay between example input and output electrical signals. In the example, any movement of the door (or window) lock can present with a variety of vibrations, sounds and movement, indicating some kind of action relative to the lock, such as, for example, rotating the handle, moving the door. In the example, sensor module 950 can be adapted to classify these and other phenomena and used to, for example, determine unauthorized (or authorized) use of the door or window lock, indicate an attempt to damage or bypass the door or window lock or track movement of the door or window, as provided in any the examples referenced in FIGS. 1-12.

In an example of implementation, sensor module 950 can be adapted for attachment inside the housing of a door lock mechanism (or a window lock mechanism). In a specific example, sensor module 950 can be adapted for coupling to an existing door lock mechanism (or window lock mechanism), for example, by using already existing mounting screws for the door or window lock mechanism. In another specific example, sensor module 950 can be provided with a door lock mechanism (or a window lock mechanism), such that the sensor and classification functions are included with acquisition of the mechanism.

FIG. 12D illustrates a sensor module 960 coupled to a door, with a motion sensor 970. In an example, sensor module 960 can be adapted to receive information from motion sensor 970 and used that information to classify one or more phenomena relative to the door environment. In an example, motion sensor 970 can, for example, measure movement in the relative environment of the door. In an example, sensor module 960 can be adapted to use the measured movement provided by motion sensor 970, along with other sensor data measured by sensor module 960, to classify the combined measured data to determine, for example, an identity of a person or persons using the door, and/or in another example, determine physical characteristics of the person or persons.

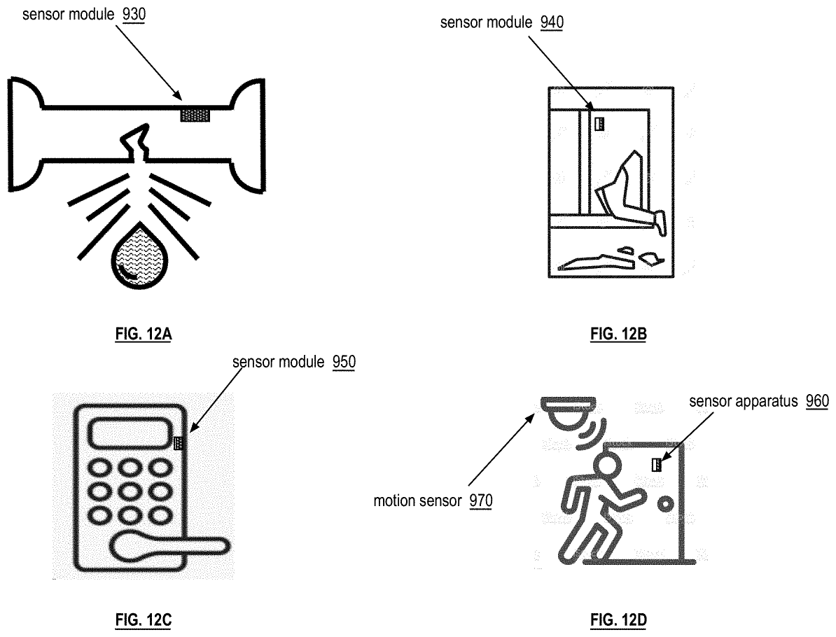

FIG. 13 is another flowchart of an example method in accordance with various aspects described herein. The method begins at step 1102, where an iterative process is used to train an artificial neural network. In an example, the iterative process can include capturing sensor responses from a plurality of sensors/sensor modules and training, for example, a cloud-based artificial neural network. In another example, sensor responses captured from a plurality of sensors/sensor modules can be used to train a local artificial neural network. In yet another example, sensor responses captured from a plurality of sensors in a sensor module can be used to train an artificial intelligence engine associated with the sensor module. At step 1104 a sensor module including the trained artificial neural network is coupled to a body/device being monitored, where a body is a moveable object or a stationary object. In the example, the sensor module can include a single sensor or a plurality of sensors associated with the sensor module to monitor a plurality of phenomena associated with an environment at step 1106. At step 1110, the artificial intelligence engine is used to classify sensor output that includes an event. In an example, the trained artificial neural network includes a plurality of previously determined (trained) classified events. In an optional example, information associated with the classified event can be provided to a training step to augment a training process. Finally, at step 1112 a classified output is transmitted to a network, where the network is any of the various networks described with reference to FIGS. 1 & 2.

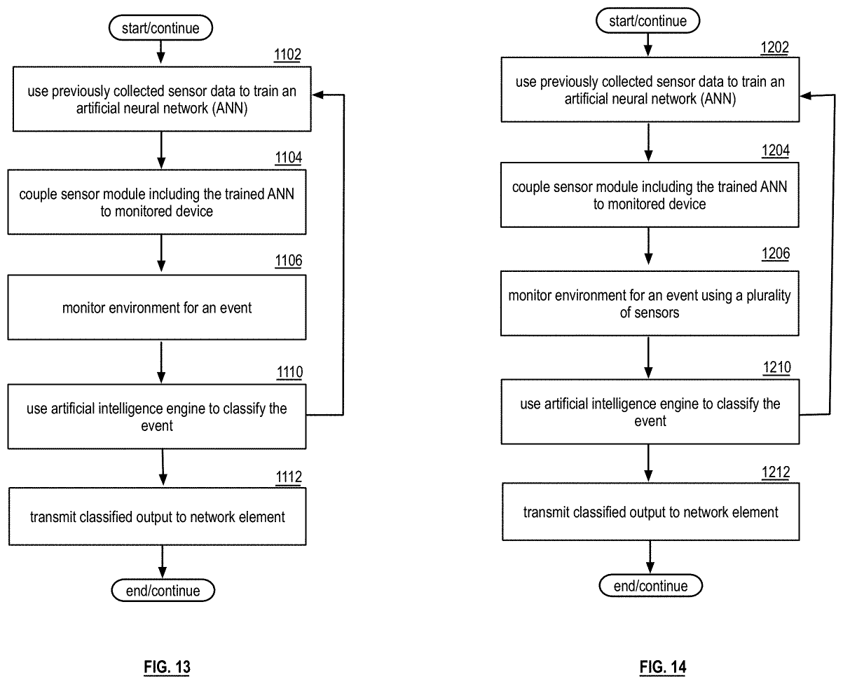

FIG. 14 is another flowchart of an example method in accordance with various aspects described herein. The method begins at step 1202, where an iterative process is used to train an artificial neural network. In an example, the iterative process can include capturing sensor responses from a plurality of sensors/sensor modules and training, for example, a cloud-based artificial neural network. In another example, sensor responses captured from a plurality of sensors/sensor modules can be used to train a local artificial neural network. In yet another example, sensor responses captured from a plurality of sensors in a sensor module can be used to train an artificial intelligence engine associated with the sensor module. At step 1204 a sensor module including the trained artificial neural network is coupled to a body/device being monitored, where a body is a moveable object or a stationary object. In the example, sensor module includes a plurality of sensors associated with the sensor module to monitor a plurality of phenomena associated with an environment at step 1204. At step 1210, the artificial intelligence engine is used to classify sensor output that includes an event. In an example, the trained artificial neural network includes a plurality of previously determined (trained) classified events. In an optional example, information associated with the classified event can be provided to a training step to augment a training process. Finally, at step 1212 a classified output is transmitted to a network, where the network is any of the various networks described with reference to FIGS. 1 & 2.

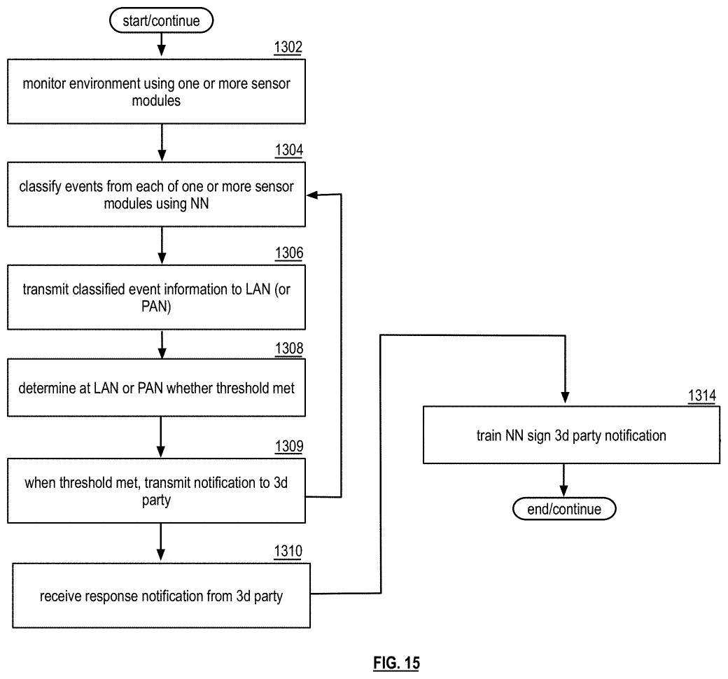

FIG. 15 illustrates a flow diagram of another example method in accordance with various aspects described herein. The method begins at step 1302, with a sensor module including a plurality of sensors associated with the sensor module being used to monitor a plurality of phenomena associated with an environment. At step 1304 an artificial neural network coupled to the sensors is used to receive output from the plurality of sensors and classify one or more events sensed in the environment and at step 1306 one or more classified events is transmitted to a local or personal area network associated with the sensor module. At step 1308, a decision engine associated with the local or personal area network is used to collect classified events from the sensor module and other sensor modules associated with the local or personal area network and in response, determine whether a notification threshold has been met. At step 1309, when a notification threshold has been met, one or more modules of one or more processors associated with the local or personal area network transmits the notification to a 3d party via another network, such as a wide area network or a local area network when a personal area network is associated with the sensor module. At step 1310 a response notification is received from the 3d party and finally, at optional step 1314 the 3d party response notification is used to augment the artificial neural network training for one or more sensor modules, including the sensor module.

In an example of implementation and operation in accordance with various aspects described herein, a sensor apparatus includes an interface configured to interface and communicate with a network and a sensor unit, wherein the sensor unit is configured to measure and report an output representative of a motion state for the sensor apparatus. The sensor apparatus can include memory that stores operational instructions; and processing circuitry operably coupled to the interface and to the memory, where the processing circuitry is configured to execute the operational instructions to execute each of the following:
receive the output signal from the sensor unit, wherein the output signal is representative of one of a plurality of motion states for the sensor unit, wherein the output signal includes information sufficient to determine one or more changes to an environment associated with the sensor apparatus;
classify, via an artificial intelligence model, the output signal according to previously classified events to produce a classified output; and
determine whether to transmit the notification to the network.

In a specific related example, the sensor unit includes least one of an accelerometer, a gyroscope, a temperature sensor and a magnetometer. In another specific related example, example motion states include any two of inclination, acceleration, rotation, rotational polarity, vibration and temperature associated with the sensor apparatus. In a further specific related example, the sensor apparatus includes an additional sensor unit, where the additional sensor unit is configured to sense one or more additional changes to the environment (in addition to motion events). In another specific related example, the additional sensor unit is configured to measure and report events associated with one or more of acoustic energy, pressure, compression, compression load, force, fluid movement, torque, chemical properties, vapor, mass flow of a gas, or humidity.

In example of implementation, a classified output, such as the classified output described above, is associated with a single event. In an alternative related implementation, the classified output is associated with changes to the environment over a period of time T. In an example of operation, processing circuitry is configured to execute the operational instructions to:
compare the classified event output to a plurality of classified events in the memory; and
when the classified event output compares favorably to a classified event of the plurality of classified events, determine to transmit the notification to the network.

In an example of implementation, one or more changes to an environment associated with the sensor apparatus include inertial events, such as inertial events associated with an object moving in the environment or where the environment is associated with the movement of the object itself. In another example of operation, processing circuitry for a sensor apparatus can be configured to execute the operational instructions to:
receive another output signal from the sensor unit;
classify, via an artificial intelligence model, the another output signal according to previously detected events to produce another classified event output; and
store information representative of the classified event output and the another classified event output in the memory.

In yet another example of implementation, a sensor apparatus can be adapted to provide notification that includes information representative of a classified event, where a network is configured to aggregate the notification with one or more additional notifications received from the sensor apparatus. In a related example, the network is a local area network, where the network is configured to consolidate a plurality of notifications to provide consolidated notifications and the network is further configured to determine whether to transmit the consolidated notifications to a third party. In an example of implementation, a power source for the sensor apparatus can include one or more of a battery, a wireless power transfer apparatus, a solar collection device or a generating apparatus, where in a related example, the generating apparatus includes one or more sensors associated with the sensor apparatus.

An example method for operation of a sensor apparatus includes sensing, by a sensor unit of the sensor apparatus, one or more changes to an environment, receiving an output signal from the sensor unit, where the output signal is representative of the one or more changes, and where th output signal includes information sufficient to determine each change of the one or more changes to the environment. The method continues by classifying, by an artificial intelligence engine of the sensor apparatus, the output signal according to previously detected events to produce a classified event output and then determining, based on the classified event output, whether to transmit the notification to the network. Finally, in response to a determination to transmit the notification to the network, transmitting the notification to the network. In a related example, the sensor unit can include one or more an accelerometer, a gyroscope, at temperature sensor and a magnetometer. In a related example, the sensor unit is configured to measure and report events associated with acceleration, rotation, rotational polarity, vibration and temperature associated with the sensor apparatus.

In a related example method for operation of a sensor apparatus, another sensor is associated with the sensor apparatus and is adapted to measure one or more additional changes to the environment. In another related example, the another sensor unit is configured to measure and report events associated with at least one of acoustic energy, pressure, compression, compression load, force, fluid movement, torque, chemical properties, vapor, mass flow of a gas, or humidity. In an example, the classified output is associated with a single event, while in an alternative example, the classified output is associated with an output signal over a period of time T. In yet another example method for operation of a sensor apparatus includes comparing the classified event output to a plurality of classified events in memory of the sensor apparatus and when the classified event output compares favorably to a classified event of the plurality of classified events, determining whether/when to transmit the notification to the network.

In a specific example of implementation and operation, a sensor module, includes a substrate, a memory, one or more processors and an inertial measurement unit, where the inertial measurement unit is configured to measure and report events associated with any of acceleration, rotation, rotational polarity, vibration and temperature. In the example, the one or more processors are configured to receive an output signal from the sensor unit, where the output signal is representative of the one or more changes in an environment and the output signal includes information sufficient to determine each change of the one or more changes to the environment and classify, via an artificial intelligence model, the output signal according to previously detected events to produce a classified event output.

It is noted that terminologies as may be used herein such as bit stream, stream, signal sequence, etc. (or their equivalents) have been used interchangeably to describe digital information whose content corresponds to any of a number of desired types (e.g., data, video, speech, text, graphics, audio, etc. any of which may generally be referred to as ‘data’).

As may be used herein, the terms “substantially” and “approximately” provides an industry-accepted tolerance for its corresponding term and/or relativity between items. For some industries, an industry-accepted tolerance is less than one percent and, for other industries, the industry-accepted tolerance is 10 percent or more. Other examples of industry-accepted tolerance range from less than one percent to fifty percent. Industry-accepted tolerances correspond to, but are not limited to, component values, integrated circuit process variations, temperature variations, rise and fall times, thermal noise, dimensions, signaling errors, dropped packets, temperatures, pressures, material compositions, and/or performance metrics. Within an industry, tolerance variances of accepted tolerances may be more or less than a percentage level (e.g., dimension tolerance of less than +/−1%). Some relativity between items may range from a difference of less than a percentage level to a few percent. Other relativity between items may range from a difference of a few percent to magnitude of differences.

As may also be used herein, the term(s) “configured to”, “operably coupled to”, “coupled to”, and/or “coupling” includes direct coupling between items and/or indirect coupling between items via an intervening item (e.g., an item includes, but is not limited to, a component, an element, a circuit, and/or a module) where, for an example of indirect coupling, the intervening item does not modify the information of a signal but may adjust its current level, voltage level, and/or power level. As may further be used herein, inferred coupling (i.e., where one element is coupled to another element by inference) includes direct and indirect coupling between two items in the same manner as “coupled to”.

As may even further be used herein, the term “configured to”, “operable to”, “coupled to”, or “operably coupled to” indicates that an item includes one or more of power connections, input(s), output(s), etc., to perform, when activated, one or more its corresponding functions and may further include inferred coupling to one or more other items. As may still further be used herein, the term “associated with”, includes direct and/or indirect coupling of separate items and/or one item being embedded within another item.

As may be used herein, the term “compares favorably”, indicates that a comparison between two or more items, signals, etc., indicates an advantageous relationship that would be evident to one skilled in the art in light of the present disclosure, and based, for example, on the nature of the signals/items that are being compared. As may be used herein, the term “compares unfavorably”, indicates that a comparison between two or more items, signals, etc., fails to provide such an advantageous relationship and/or that provides a disadvantageous relationship. Such an item/signal can correspond to one or more numeric values, one or more measurements, one or more counts and/or proportions, one or more types of data, and/or other information with attributes that can be compared to a threshold, to each other and/or to attributes of other information to determine whether a favorable or unfavorable comparison exists. Examples of such a advantageous relationship can include: one item/signal being greater than (or greater than or equal to) a threshold value, one item/signal being less than (or less than or equal to) a threshold value, one item/signal being greater than (or greater than or equal to) another item/signal, one item/signal being less than (or less than or equal to) another item/signal, one item/signal matching another item/signal, one item/signal substantially matching another item/signal within a predefined or industry accepted tolerance such as 1%, 5%, 10% or some other margin, etc. Furthermore, one skilled in the art will recognize that such a comparison between two items/signals can be performed in different ways. For example, when the advantageous relationship is that signal 1 has a greater magnitude than signal 2, a favorable comparison may be achieved when the magnitude of signal 1 is greater than that of signal 2 or when the magnitude of signal 2 is less than that of signal 1. Similarly, one skilled in the art will recognize that the comparison of the inverse or opposite of items/signals and/or other forms of mathematical or logical equivalence can likewise be used in an equivalent fashion. For example, the comparison to determine if a signal X>5 is equivalent to determining if −X<−5, and the comparison to determine if signal A matches signal B can likewise be performed by determining −A matches −B or not(A) matches not(B). As may be discussed herein, the determination that a particular relationship is present (either favorable or unfavorable) can be utilized to automatically trigger a particular action. Unless expressly stated to the contrary, the absence of that particular condition may be assumed to imply that the particular action will not automatically be triggered. In other examples, the determination that a particular relationship is present (either favorable or unfavorable) can be utilized as a basis or consideration to determine whether to perform one or more actions. Note that such a basis or consideration can be considered alone or in combination with one or more other bases or considerations to determine whether to perform the one or more actions. In one example where multiple bases or considerations are used to determine whether to perform one or more actions, the respective bases or considerations are given equal weight in such determination. In another example where multiple bases or considerations are used to determine whether to perform one or more actions, the respective bases or considerations are given unequal weight in such determination.

As may be used herein, one or more claims may include, in a specific form of this generic form, the phrase “at least one of a, b, and c” or of this generic form “at least one of a, b, or c”, with more or less elements than “a”, “b”, and “c”. In either phrasing, the phrases are to be interpreted identically. In particular, “at least one of a, b, and c” is equivalent to “at least one of a, b, or c” and shall mean a, b, and/or c. As an example, it means: “a” only, “b” only, “c” only, “a” and “b”, “a” and “c”, “b” and “c”, and/or “a”, “b”, and “c”.

As may also be used herein, the terms “processing module”, “processing circuit”, “processor”, “processing circuitry”, and/or “processing unit” may be a single processing device or a plurality of processing devices. Such a processing device may be a microprocessor, micro-controller, digital signal processor, microcomputer, central processing unit, field programmable gate array, programmable logic device, state machine, logic circuitry, analog circuitry, digital circuitry, and/or any device that manipulates signals (analog and/or digital) based on hard coding of the circuitry and/or operational instructions. The processing module, module, processing circuit, processing circuitry, and/or processing unit may be, or further include memory and/or an integrated memory element, which may be a single memory device, a plurality of memory devices, and/or embedded circuitry of another processing module, module, processing circuit, processing circuitry, and/or processing unit. Such a memory device may be a read-only memory, random access memory, volatile memory, non-volatile memory, static memory, dynamic memory, flash memory, cache memory, and/or any device that stores digital information. Note that if the processing module, module, processing circuit, processing circuitry, and/or processing unit includes more than one processing device, the processing devices may be centrally located (e.g., directly coupled together via a wired and/or wireless bus structure) or may be distributedly located (e.g., cloud computing via indirect coupling via a local area network and/or a wide area network). Further note that if the processing module, module, processing circuit, processing circuitry and/or processing unit implements one or more of its functions via a state machine, analog circuitry, digital circuitry, and/or logic circuitry, the memory and/or memory element storing the corresponding operational instructions may be embedded within, or external to, the circuitry comprising the state machine, analog circuitry, digital circuitry, and/or logic circuitry. Still further note that, the memory element may store, and the processing module, module, processing circuit, processing circuitry and/or processing unit executes, hard coded and/or operational instructions corresponding to at least some of the steps and/or functions illustrated in one or more of the Figures. Such a memory device or memory element can be included in an article of manufacture.

One or more embodiments have been described above with the aid of method steps illustrating the performance of specified functions and relationships thereof. The boundaries and sequence of these functional building blocks and method steps have been arbitrarily defined herein for convenience of description. Alternate boundaries and sequences can be defined so long as the specified functions and relationships are appropriately performed. Any such alternate boundaries or sequences are thus within the scope and spirit of the claims. Further, the boundaries of these functional building blocks have been arbitrarily defined for convenience of description. Alternate boundaries could be defined as long as the certain significant functions are appropriately performed. Similarly, flow diagram blocks may also have been arbitrarily defined herein to illustrate certain significant functionality.

To the extent used, the flow diagram block boundaries and sequence could have been defined otherwise and still perform the certain significant functionality. Such alternate definitions of both functional building blocks and flow diagram blocks and sequences are thus within the scope and spirit of the claims. One of average skill in the art will also recognize that the functional building blocks, and other illustrative blocks, modules and components herein, can be implemented as illustrated or by discrete components, application specific integrated circuits, processors executing appropriate software and the like or any combination thereof

In addition, a flow diagram may include a “start” and/or “continue” indication. The “start” and “continue” indications reflect that the steps presented can optionally be incorporated in or otherwise used in conjunction with one or more other routines. In addition, a flow diagram may include an “end” and/or “continue” indication. The “end” and/or “continue” indications reflect that the steps presented can end as described and shown or optionally be incorporated in or otherwise used in conjunction with one or more other routines. In this context, “start” indicates the beginning of the first step presented and may be preceded by other activities not specifically shown. Further, the “continue” indication reflects that the steps presented may be performed multiple times and/or may be succeeded by other activities not specifically shown. Further, while a flow diagram indicates a particular ordering of steps, other orderings are likewise possible provided that the principles of causality are maintained.

The one or more embodiments are used herein to illustrate one or more aspects, one or more features, one or more concepts, and/or one or more examples. A physical embodiment of an apparatus, an article of manufacture, a machine, and/or of a process may include one or more of the aspects, features, concepts, examples, etc. described with reference to one or more of the embodiments discussed herein. Further, from figure to figure, the embodiments may incorporate the same or similarly named functions, steps, modules, etc. that may use the same or different reference numbers and, as such, the functions, steps, modules, etc. may be the same or similar functions, steps, modules, etc. or different ones.

Unless specifically stated to the contra, signals to, from, and/or between elements in a figure of any of the figures presented herein may be analog or digital, continuous time or discrete time, and single-ended or differential. For instance, if a signal path is shown as a single-ended path, it also represents a differential signal path. Similarly, if a signal path is shown as a differential path, it also represents a single-ended signal path. While one or more particular architectures are described herein, other architectures can likewise be implemented that use one or more data buses not expressly shown, direct connectivity between elements, and/or indirect coupling between other elements as recognized by one of average skill in the art.

The term “module” is used in the description of one or more of the embodiments. A module implements one or more functions via a device such as a processor or other processing device or other hardware that may include or operate in association with a memory that stores operational instructions. A module may operate independently and/or in conjunction with software and/or firmware. As also used herein, a module may contain one or more sub-modules, each of which may be one or more modules.

As may further be used herein, a computer readable memory includes one or more memory elements. A memory element may be a separate memory device, multiple memory devices, or a set of memory locations within a memory device. Such a memory device may be a read-only memory, random access memory, volatile memory, non-volatile memory, static memory, dynamic memory, flash memory, cache memory, a quantum register or other quantum memory and/or any other device that stores data in a non-transitory manner. Furthermore, the memory device may be in a form of a solid-state memory, a hard drive memory or other disk storage, cloud memory, thumb drive, server memory, computing device memory, and/or other non-transitory medium for storing data. The storage of data includes temporary storage (i.e., data is lost when power is removed from the memory element) and/or persistent storage (i.e., data is retained when power is removed from the memory element). As used herein, a transitory medium shall mean one or more of: (a) a wired or wireless medium for the transportation of data as a signal from one computing device to another computing device for temporary storage or persistent storage; (b) a wired or wireless medium for the transportation of data as a signal within a computing device from one element of the computing device to another element of the computing device for temporary storage or persistent storage; (c) a wired or wireless medium for the transportation of data as a signal from one computing device to another computing device for processing the data by the other computing device; and (d) a wired or wireless medium for the transportation of data as a signal within a computing device from one element of the computing device to another element of the computing device for processing the data by the other element of the computing device. As may be used herein, a non-transitory computer readable memory is substantially equivalent to a computer readable memory. A non-transitory computer readable memory can also be referred to as a non-transitory computer readable storage medium.

One or more functions associated with the methods and/or processes described herein can be implemented via a processing module that operates via the non-human “artificial” intelligence (AI) of a machine. Examples of such AI include machines that operate via anomaly detection techniques, decision trees, association rules, expert systems and other knowledge-based systems, computer vision models, artificial neural networks, convolutional artificial neural networks, support vector machines (SVMs), Bayesian networks, genetic algorithms, feature learning, sparse dictionary learning, preference learning, deep learning and other machine learning techniques that are trained using training data via unsupervised, semi-supervised, supervised and/or reinforcement learning, and/or other AI. The human mind is not equipped to perform such AI techniques, not only due to the complexity of these techniques, but also due to the fact that artificial intelligence, by its very definition — requires “artificial” intelligence—i.e., machine/non-human intelligence.

One or more functions associated with the methods and/or processes described herein can be implemented as a large-scale system that is operable to receive, transmit and/or process data on a large-scale. As used herein, a large-scale refers to a large number of data, such as one or more kilobytes, megabytes, gigabytes, terabytes or more of data that are received, transmitted and/or processed. Such receiving, transmitting and/or processing of data cannot practically be performed by the human mind on a large-scale within a reasonable period of time, such as within a second, a millisecond, microsecond, a real-time basis or other high speed required by the machines that generate the data, receive the data, convey the data, store the data and/or use the data.

One or more functions associated with the methods and/or processes described herein can require data to be manipulated in different ways within overlapping time spans. The human mind is not equipped to perform such different data manipulations independently, contemporaneously, in parallel, and/or on a coordinated basis within a reasonable period of time, such as within a second, a millisecond, microsecond, a real-time basis or other high speed required by the machines that generate the data, receive the data, convey the data, store the data and/or use the data.

One or more functions associated with the methods and/or processes described herein can be implemented in a system that is operable to electronically receive digital data via a wired or wireless communication network and/or to electronically transmit digital data via a wired or wireless communication network. Such receiving and transmitting cannot practically be performed by the human mind because the human mind is not equipped to electronically transmit or receive digital data, let alone to transmit and receive digital data via a wired or wireless communication network.

One or more functions associated with the methods and/or processes described herein can be implemented in a system that is operable to electronically store digital data in a memory device. Such storage cannot practically be performed by the human mind because the human mind is not equipped to electronically store digital data.

One or more functions associated with the methods and/or processes described herein may operate to cause an action by a processing module directly in response to a triggering event—without any intervening human interaction between the triggering event and the action. Any such actions may be identified as being performed “automatically”, “automatically based on” and/or “automatically in response to” such a triggering event. Furthermore, any such actions identified in such a fashion specifically preclude the operation of human activity with respect to these actions—even if the triggering event itself may be causally connected to a human activity of some kind.

While particular combinations of various functions and features of the one or more embodiments have been expressly described herein, other combinations of these features and functions are likewise possible. The present disclosure is not limited by the particular examples disclosed herein and expressly incorporates these other combinations.

What is claimed is:

1. A sensor apparatus comprising:
an interface configured to interface and communicate with a network;
a sensor unit, wherein the sensor unit is configured to measure and report an output representative of a motion state for the sensor apparatus;
memory that stores operational instructions; and
processing circuitry operably coupled to the interface and to the memory, wherein the processing circuitry is configured to execute the operational instructions to:
receive the output signal from the sensor unit, wherein the output signal is representative of one of a plurality of motion states for the sensor unit, wherein the output signal includes information sufficient to determine one or more changes to an environment associated with the sensor apparatus;
classify, via an artificial intelligence model, the output signal according to previously classified events to produce a classified output; and
determine whether to transmit a notification to the network.

2. The sensor apparatus of claim 1, wherein the sensor unit includes least one of an accelerometer, a gyroscope, a temperature sensor and a magnetometer.

3. The sensor apparatus of claim 1, wherein the motion states include any two of inclination, acceleration, rotation, rotational polarity, vibration and temperature associated with the sensor apparatus.

4. The sensor apparatus of claim 1, further comprising:
another sensor unit, wherein the another sensor unit is configured to sense one or more additional changes to the environment.

5. The sensor apparatus of claim 4, wherein the another sensor unit is configured to measure and report events associated with at least one of acoustic energy, pressure, compression, compression load, force, fluid movement, torque, chemical properties, vapor, mass flow of a gas, or humidity.

6. The sensor apparatus of claim 1, wherein the classified output is associated with a single event.

7. The sensor apparatus of claim 1, wherein the classified output is associated with changes to the environment over a period of time T.

8. The sensor apparatus of claim 1, wherein the processing circuitry is further configured to execute the operational instructions to:
compare the classified event output to a plurality of classified events in the memory; and
when the classified event output compares favorably to a classified event of the plurality of classified events, determine to transmit the notification to the network.

9. The sensor apparatus of claim 1, wherein the one or more changes are associated with inertial events.

10. The sensor apparatus of claim 1, wherein the processing circuitry is further configured to execute the operational instructions to:
receive another output signal from the sensor unit;
classify, via an artificial intelligence model, the another output signal according to previously detected events to produce another classified event output; and
store information representative of the classified event output and the another classified event output in the memory.

11. The sensor apparatus of claim 1, wherein the notification includes information representative of a classified event and wherein the network is configured to aggregate the notification with one or more additional notifications received from the sensor apparatus.

12. The sensor apparatus of claim 1, wherein the notification includes information representative of a classified event and wherein the information representative of a classified event is adapted indicate a relative importance of the classified event.

13. The sensor apparatus of claim 1, wherein the notification includes information representative of a classified event and wherein the information representative of a classified event is adapted to trigger a specific action based on the classified event.

14. The sensor apparatus of claim 1, wherein the network is a local area network, wherein the network is configured to consolidate a plurality of notifications to provide consolidated notifications; and wherein the network is further configured to determine whether to transmit the consolidated notifications to a third party.

15. The sensor apparatus of claim 1, wherein the sensor unit includes a plurality of sensors, wherein the processing circuitry is further configured to execute the operational instructions to:
turn off power to at least some of the plurality of sensors in a first mode of operation;
determine whether motion is detected in one or more sensors of the plurality of sensors that are not turned off in the first mode; and
in response to a determination that motion is detected, turn on power to the at least some of the plurality of sensors in a second mode of operation.

16. The sensor apparatus of claim 1, further comprising:
a power source, wherein the power source is selected from a list that includes at least one of:
a battery;
a wireless power transfer apparatus;
a solar collection device; and
a generating apparatus, wherein the generating apparatus includes one or more sensors associated with the sensor apparatus.

17. A method for execution by a sensor apparatus, the method comprises:
sensing, by a sensor unit of the sensor apparatus, one or more changes to an environment;
receiving an output signal from the sensor unit, wherein the output signal is representative of the one or more changes, wherein the output signal includes information sufficient to determine each change of the one or more changes to the environment;
classifying, by an artificial intelligence engine of the sensor apparatus, the output signal according to previously detected events to produce a classified event output;
determining, based on the classified event output, whether to transmit a notification to the network; and
in response to a determination to transmit the notification to the network, transmitting the notification to the network.

18. The method of claim 17, wherein the sensor unit includes least one of an accelerometer, a gyroscope, at temperature sensor and a magnetometer.

19. The method of claim 17, wherein the sensor unit is configured to measure and report events associated with any two of acceleration, rotation, rotational polarity, vibration and temperature associated with the sensor apparatus.

20. The method of claim 17, further comprising:
sensing, by another sensor associated with the sensor apparatus, one or more additional changes to the environment.

21. The method of claim 17, wherein the another sensor unit is configured to measure and report events associated with at least one of acoustic energy, pressure, compression, compression load, force, fluid movement, torque, chemical properties, vapor, mass flow of a gas, or humidity.

22. The method of claim 17, wherein the classified output is associated with a single event.

23. The method of claim 17, wherein the classified output is associated with an output signal over a period of time T.

24. The method of claim 17, further comprising:
comparing the classified event output to a plurality of classified events in memory of the sensor apparatus; and
when the classified event output compares favorably to a classified event of the plurality of classified events, determining to transmit the notification to the network.

25. A sensor module, comprising:
a substrate;
a memory;
an inertial measurement unit, wherein the inertial measurement unit is configured to measure and report events associated with any two of acceleration, rotation, rotational polarity, vibration and temperature; and
one or more processors, wherein the one or more processors are configured to receive an output signal from the inertial measurement unit, wherein the output signal is
representative of one or more changes in an environment, wherein the output signal includes information sufficient to determine each change of the one or more changes in the environment and classify, via an artificial intelligence model, the output signal according to previously detected events to produce a classified event output.
